(19) United States
(12) Patent Application Publication
(10) Pub. No.: US 2008/0109320 A1
(43) Pub. Date: May 8, 2008

(54) Interactive RFID Transaction Automation

(76) Inventor: Jonathan Kleinhans, Lockport, NY (US)

Correspondence Address: GREENBERG & LIEBERMAN, LLC, 2141 WISCONSIN AVE, N.W., SUITE C-2, WASHINGTON, DC, 20007, US

(21) Appl. No.: 11/556,829

(22) Filed: Nov. 6, 2006

(51) Int. Cl. G06Q 30/00; G08B 23/00

(52) U.S. Cl. 705/26; 340/573.1

(57) ABSTRACT

A RFID device and method that is used for businesses that demand a secure and speedy transaction method. The RFID device is read by a RFID reader and the customer's order and much of transaction are automated. The RFID device is capable of being used in drive-through businesses or can be carried on the person and will reduce wait lines at a business. The system used by the merchant prevents a customer with a forged tag from making any purchases. It is a secure system.

### FIELD OF THE INVENTION

The present invention relates to customized RFID automation to facilitate accurate, secure, convenient, and streamlined automated transactions between a customer and a business.

### BACKGROUND OF THE INVENTION

For years, restaurants and other product and service providers have endeavored to deliver to the consumer in the fastest modes possible. The faster a restaurant or service provider can deliver, the more customers they can serve, and the greater their profits. At the same time, customers will be happier and more willing to take time out of their busy schedules in order to visit the product providers. The current state of the art provides a variety of methods for ensuring that the consumer moves through a drive-through line as quickly as possible. For example, there are multiple windows, each with a dedicated purpose, at a typical restaurant. There will usually be a separate window to order, pay, and receive food at. Also, some drive-throughs have view screens so that the consumer can confirm the accuracy of an order and help prevent delays in the drive though line. However, efforts by restaurants and other product and service providers have not alleviated the backup that consumers still face when waiting in a drive-through line.

Alternatively, or in addition to trying to keep a drive though line moving, businesses have attempted to make waiting in a drive though line more enjoyable by providing music, video entertainment, etc. In short, it seems that businesses have done all that they possibly can in order to speed up the drive-through line and/or make the drive-through experience more pleasurable.

While credit card transactions typically speed up the payment process at a drive-through because there is no cash to handle and no need to provide change, it still takes time for the credit card transaction to process—arguably making the credit card transaction more time consuming than the cash transaction. Despite this, many restaurants have begun to accept credit cards at drive-through windows in an attempt to make some improvements in drive-through wait time. While the advantages of credit cards at drive-through windows is debatable, lines remain long during peak hours, and there is still a need to speed up the drive-through experience, particularly the ordering and payment process that will make credit card transactions even faster.

There are a number of technologies with the potential to speed up the payment process. These technologies use an identification scheme that is unique to the customer. Two examples of such identification schemes are bar codes and discount cards. Both are small enough to fit on key chains. Another method of identification is radio frequency identification, or RFID. Lately, RFID tags have become popular as payment methods, and are currently being used for payment of gasoline, tolls, and even non-payment activities such as starting automobiles (many auto keys are imbedded with RFID immobilizers). RFID is convenient because it can make transactions between a customer and a merchant more efficient by eliminating the need to carry currency. RFID can also be used to identify patterns in what a customer purchases or to streamline the checkout process at a supermarket. Unlike the present invention, existing attempts to speed up drive-through lines still fail because the consumer must still order. While payment has become somewhat automatic, if the right technology is employed, the order process still remains an order process. And it is the ordering step that forces drive-through lines to called just that which they are—“lines.” There is a need to speed up the ordering process beyond the capabilities of relevant art.

There are a number of technologically advanced systems for purchasing goods and/or services, as illustrated in the following relevant patents.

U.S. Pat. No. 6,507,279 issued to Loof on Jan. 14, 2003, is a complete integrated self-checkout system and method. While it uses RFID technology, it is intended to allow marketing advertisements and pricing to be directed to a specific individual through their PDA or cellular phone. Unlike the present invention, there is no attempt to speed up ordering in Loof's concept.

U.S. Pat. No. 6,976,634 issued to Washington et al. on Dec. 20, 2005, is an ATM currency cassette with RFID tag. Unlike the present invention, Washington et al.'s concept is intended for use with ATM machines. Further, unlike the present invention, there is no attempt to speed up ordering in Washington et al.'s concept.

US Publication 2004/0016796 published for Hanna et al. on Jan. 29, 2004, is an automated banking apparatus and method. It has a RFID tag to obtain merchant information when a merchant makes a deposit at an ATM. Unlike the present invention, Hanna et al.'s concept is not an attempt to speed up the ordering process in a drive-through line.

US Publication 2005/0033686 published for Peart et al. on Feb. 10, 2005, is a system and method for securing sensitive information during completion of a transaction. The RFID is used in conjunction with a proxy code to secure transactions, but unlike the present invention, Peart et al.'s concept does not in any way speed up the ordering process in a drive-through line.

US Publication 2005/0088284 published for Zai et al. on Apr. 28, 2005, is a method and system of using a RFID reader network to provide a large operating area. It enables multiple RFID readers to simultaneously operate. Unlike the present invention, Zai et al's concept does not in any way speed up the ordering process in a drive-through line.

US Publication 2005/0160003 published for Berardi et al. on Jul. 21, 2005, is a system and method for providing consumers with an incentive to use a RFID transaction device at a merchant location. A RFID transaction device account number includes a marker for identifying that the transaction is being completed using a RFID transaction device. A merchant system recognizes the marker and provides incentives to the RFID user accordingly. However, unlike the present invention, Berardi et al.'s concept does not provide a means for speeding up the ordering process in a drive-through.

US Publication 2005/0177423 published for Swanson, Sr. on Aug. 11, 2005, is a system and method of using RFID devices to analyze customer traffic patterns in order to improve a merchant's layout. Unlike the present invention, it is not used to automate and facilitate a purchase for a regular customer.

US Publication 2005/0184155 published for Pinkus on Aug. 25, 2005, is an automatic payment system using RFID tags. It enables cashless fueling transactions through the use of vehicle-based decal sticker RFID tags. Unlike the present invention, Pinkus' concept cannot increase the ordering process in drive-through lines; but rather, Pinkus' device is concerned with payment and enabling special promotional offers. Further, unlike the present invention Pinkus' concept cannot provide a customer with any specific product or service that the customer typically purchases without customer intervention—it just handles payment once the customer has made a specific product or service choice at each visit to a vendor.

US Publication 2005/0187882 published for Sovio et al. on Aug. 25, 2005, is an electronic payment scheme in a mobile environment for short-range transactions. It enables a user to make a transaction or a self-service checkout without having to use currency. However, unlike the present invention, it does not increase the speed of the ordering process in a drive-through line. Further, unlike the present invention, it is not used to automate a purchase for a regular customer.

US Publication 2005/0242177 published for Roberge et al. on Nov. 3, 2005 is a RFID-based system and method of conducting financial transactions. However, unlike the present invention, it does not increase the speed of ordering in a drive-through line. Further, unlike the present invention, it is not used to automate a purchase for a regular customer.

US Publication 2005/0248459 published for Bonalle et al. on Nov. 10, 2005, is a system and method for providing a RFID transaction device. It is a way to attach RFID devices to various articles, but offers no way to increase the speed of ordering in a drive-through line. Further, unlike the present invention, it is not used to automate a purchase for a regular customer.

Thus, there is still a need for increasing the speed at which a customer can place an order in a drive-through line. This need is independent of cooking and preparation speed. By speeding up the entire ordering process, businesses could all but eliminate the current necessity of order confirmation and in line entertainment to pacify customers. More specifically, by speeding up the ordering process, the total time spent in the drive-through line could be reduced significantly, thus increasing profits and efficiency for the merchant and convenience for the customer.

Therefore, there is a need for a new device and process that will assist in speeding up the ordering and payment processes. There is also a need for such a device and process that is capable of being carried by a person or in a car. Further, there is a need for a RFID device and process that can not only automate the ordering process for the customer, but can also make the transaction of currency between the customer and a business more efficient and secure so that financial transactions provide an increased level of security when the ordering process is automated.

### SUMMARY OF THE INVENTION

The present invention is especially useful for a market niche that has regular customers that consistently order the same thing. This new and improved RFID device and process combines: 1) the ordering of a particular product based on a client's purchase history, with 2) facilitating the exchange of currency by making the transaction more or less cashless. Thus, a person would be able to go to a business where they are a regular customer, and without having to order “the usual” or pull out their wallet, obtain the product they desire and have the amount automatically debited from the amount on their RFID device. Using RFID for ordering and payment will simplify the purchase process for both the customer and the merchant. According to the present invention, the customer has the added convenience of increased movement in a drive-through line, and the merchant can be more efficiently and dynamically execute a business plan.

The present invention is intended for any business, but is particularly useful and well suited for a business with a market that has a customer base of repeat customers or customers that come back day after day and always order the same thing. As an example, examine a regular customer who purchases an inexpensive cup of coffee at the drive-through window of a local coffee shop. The average time spent in the drive-through line is in excess of two minutes. As much as 30 seconds of this time may be spent on ordering and payment. Wasting 30 seconds for ordering and payment is essentially wasted time that doesn't exist with a customer and business employing the present invention.

In order to streamline the process, the present invention provides a RFID solution could be implemented where customers of a business could buy a RFID tag for a certain amount, and then put money on their account for an initial balance. In one embodiment of the present invention, the RFID tag would be coded for a certain purchase upon each visit to the business. For example, a RFID tag could be purchased for $25 and would be coded for a doughnut and large coffee. Thus, a customer with that RFID tag would have a prepaid card and be able to avoid the time consuming processes of fumbling for money, waiting for change, and very importantly ordering would be automatic. There would be no need to do anything but to drive-through the drive-through line and pick up a doughnut and large coffee, according to the aforementioned example. This is a beneficial and efficient solution for both the customer and the business. The more cups of coffee sold in a given amount of time, the more revenue for the business, and the customer also spends less time in a drive-through line, so the customer is happier than the average drive-through customer.

There are other embodiments of the present invention. Employing another coffee shop example to illustrate the present invention, at a particular coffee shop a customer might have a particular coffee that they always purchase with specific instructions such as “medium French roast, non-fat, skim, a shot of hazelnut, and double espresso.” The present invention facilitates transactions with customers that have very specific tastes. The customer could simply have their RFID tag scanned and get their coffee without the hassle of an explanation and the risk of a botched order because the RFID tag would already be coded with a preference or be associated with a preference indication in a storage median, preferably a database, accessed by the business. In short, via the present invention, without uttering a word or opening a car window, the customer can order and pay for the coffee. The only delay in receiving the coffee is preparation time for the coffee. When the coffee is ready the customer only has to open the car window and grab the coffee.

There is a significant business advantage for both the customer and the business in an RFID order process. In one embodiment of the present invention, the RFID account could be linked to credit cards and serve as a universal drive-through currency, or may be used as a key fob linked to the customer's account to use inside stores or in businesses without drive-through lines. For example, self check-out is commonplace at many food stores. The delay for customers using self check-out lines is scanning each item being purchased and entering payment information. The payment information and purchase info could be on an RFID card or associated in a storage median, preferably a database, correlated with an RFID card. A customer would merely buy normal items that the customer buys, and simply walk out the door of the store. There would no need to wait in any check-out line so long as the customer could be trusted to not sneak an extra item. Right now though, customers in self check-out lines are trusted to scan all items, so another leap of trust would not be all that much.

Companies that do not have a non-niche market can also benefit from the present invention. Such companies can provide the ordering simplicity of the present invention via product specific RFID tags as a convenience to their customers and gain a competitive and efficiency advantage over competition. Eventually, consumer demand for the present invention could be so high that businesses would be forced to accept RFID order transactions as part of their sales scheme.

Additionally, businesses would also benefit from RFID based ordering and sales, according to the present invention. Potentially, all drive-through lines could use the technology of the present invention, and all businesses that do not have drive-through lines could use RFID tags of the present invention on customers' key chains inside.

As a corollary to one of the embodiments of the present invention aforementioned, a customer inside store (such as inside a coffee shop, could simply present the customer's RFID tag and the merchant would be able to view the customer's regular order (like a cup of coffee) on a view screen receiving order info when the RFID tag is matched to a storage median, preferably a database. Then the merchant would hand the customer the order without having to physically exchange currency or even conversation. The cost of the product being sold would be automatically and electronically deducted from the customer's RFID account. If the customer were trying to forge another's tag, the present invention would catch the forgery and prevent the customer from purchasing a product through the present invention's multiple layers of security. Long lines of customers oftentimes result in customers feeling unhappy, and oftentimes, not even returning to a merchant. The present invention prevents “lost business” associated with wait lines by employing a convenient device that a person can carry on their key chain.

At certain restaurants, customers have the convenience of pulling up outside for service. There is a better way to provide service then having a waitress run outside to find out who the customer is, then run inside to check if the customer's food is ready, then grab the order and deliver it, and finally, run back inside to bring the credit card and back out to the customer to sign the receipt. This is a substantial amount of wasted time and running around that could be eliminated. With the present invention, the waitresses could actually tell who is outside waiting, what order the customer desires, and automatically deduct the cost for that order from the account linked to their RFID tag/key fob. In fact, the waitress would not need to do anything but bring the food to the customer. Other applications of the present invention could include picking up a prescription at a pharmacy or going to a drive-through liquor store (in certain states where legal) without uttering a single word.

Order accuracy is always a problem when businesses serve customers, and with the present invention, accuracy problems are essentially alleviated. High winds, loud engines, language barriers, etc. are all not problems with the present invention, as ordering is automated, and preferably no words need to be spoken whatsoever.

It is an object of the present invention to facilitate the purchase of a product by a customer that frequents a business regularly and tends to order the same thing day after day.

It is an object of the present invention to eliminate long waits by streamlining the ordering process and the exchange of currency through the use of RFID technology.

It is an object of the present invention for this particular technology to not only be used in market niches with repeat customers, but also in markets without repeat customers, in order to give these businesses a market advantage over similar businesses. The advantage in such markets would be that the RFID technology would provide another payment method for customers.

It is an object of the present invention for a customer to be able to order “the usual” without having to pull out their wallet and break a large bill for something inexpensive.

It is an object of the present invention to create a secure and rapid means of exchanging money by preventing fraudulent purchases by customers with forged tags and by automating transactions between customers and merchants.

The present invention allows the user to determine the conditions where authentication is required. Encryption will also be performed throughout the infrastructure. The users can choose to be authenticated every X (3, 10, 15) transactions by authentication mechanism Y (PIN, Passphrase, Photo ID, etc). Additionally, the present invention allows the user to require authentication on purchases over a certain dollar amount. This security is one of the biggest advantages of the present invention because if payment and ordering is completely automated, there preferably needs be some check that the customer really is the customer, and not someone using a stolen RFID tag.

Basically, the method of the present invention, even without encryption, has the potential to be much more secure than any relevant art. There is nothing that can prevent RFID tags from being duplicated—something that has tried to be resolved by encrypting the data on the tag. Information on this issue is available at http://rfidanalysis.org/. There has been a hesitancy to implement RFID technology because the technology has not yet been proven to be secure. In order for people to accept RFID technology, they must know that it is secure. The present invention has been designed to be secure and makes every effort to prevent attacks upon the RFID account.

These objects combined with the other goals of the invention and the various features of novelty that characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a flowchart of the method of the present invention.

FIG. 2 is a flowchart of the interaction between the RFID devices and readers.

### DETAILED DESCRIPTION OF THE PREFERRED EMBODIMENT(S)

The present invention is intended for any business but is particularly useful for a business that has a market niche with repeat customers. These repeat customers are in the best position to benefit from the “usual order” element of the design. However, even non-repeat customers might be able to take advantage of the faster RFID payment process.

The system is interactive in order to streamline the transaction process. The merchant would have the necessary authentication devices to complete order processing, authentication, and information disclosure. The process of entertaining the requests from the customer is handled by a terminal. This terminal tells the RFID reader to grab the data, checks the data through the infrastructure sets up the necessary functions to be performed during the transaction, determines how they will be facilitated, and handles communications with other devices dependent upon the application. The infrastructure is essentially anything that communicates with or facilitates communication with the RFID reader but for the RFID tag. The application is a software/hardware solution for associating characteristics and other variables with the identification from the tag.

In the preferred embodiment of the present invention, the information within the terminal will be dynamic, able to communicate with the RFID tags, re-sequence the data, handle authentication means, and accept dynamic updates from authorized servers. Thus, adding additional functions to the system will not be a difficult process and will be capable of being handled in a fashion that is invisible to the user. With a dynamic system, businesses and customers will be able to modify the way “the usual” is determined in order to tailor the system to their particular business market and eliminate expensive redundancy. In one embodiment of the present invention, read-only RFID tags are employed to protect against “zapping” tags; whereas in another embodiment of the present invention, re-writable RFID tags are employed.

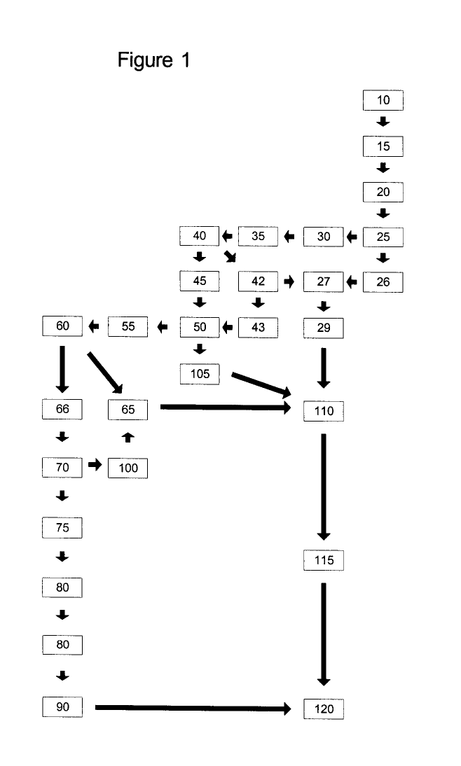

The following is only one embodiment of the process of the present invention. As shown in FIG. 1, the transaction begins (10). The tag is read (15) and the application validates in the storage median (20), preferably a database. The system checks the validity of the customer's RFID tag (25). If the customer does not have a valid RFID tag (26), the order proceeds as a conventional order (27). If the customer has a valid RFID tag (30), the routine for this is begun (35) and the customer is asked if they want “the usual” (40).

Asking if the customer wants “the usual” (40) does not necessarily require that the customer is queried. Asking if the customer wants “the usual” (40) can be waiting for the customer to confirm that the customer wants the usual. More specifically, the customer can confirm that “the usual” is desired by saying nothing—in which case the lack of a customer response would be taken as a confirmation that “the usual” is desired. Alternatively, the customer can confirm that “the usual” is desired by demonstratively affirming so, such as by saying, “Yes,” with or without prompting. If the customer does not want “the usual,” then the customer indicates whether the customer still wants to pay electronically via the RFID (42)—and it would be preferably assumed that the customer does want to pay electronically but order conventionally (43) if the customer says nothing so that the authentication bit of the RFID card is checked (50), or in other words, the RFID data that identifies the customer will be read off of the card. If the customer does not want to pay electronically via the RFID (42), then the order proceeds as a conventional order (27), such that it as if no RFID exists. If the order proceeds as a conventional order (27), then conventional payment occurs (29), and the customer is given the customer's order (110).

If the customer wants “the usual,” the customer's “usual order” is placed electronically (45). While in the preferred version the “usual order” will be the same, it is contemplated that “the usual” could be dependent on several external factors. In one embodiment of the design, such factors would be determined by a business or customer and could include the day of the week, time of day, or external temperature. For example, on a Friday, a customer could desire a particular variety of coffee; after 6:00 PM, a customer could desire decaf; or when the temperature is above 70 degrees, a customer could desire iced coffee instead of hot coffee. If the customer pulled into the drive-through on an 80 degree day with their RFID, they would automatically be given an iced coffee.

In one embodiment of the design, a device within the infrastructure would be encoded with information regarding external factors that affect what “the usual” is, and the appropriate order could be automatically placed based upon this. For example, such a device within the infrastructure could be a thermometer that would read the ambient temperature to allow an application that is part of the infrastructure to provide a beverage that is appropriate for the weather—as in a hot beverage on a cold day. In theory, a temperature sensor could be attached to the RFID tag (which is conventional) or embedded within the merchant's location. Alternatively, temperature could be even updated online from a weather service or other temperature posting. Moreover, any variable or situation could be measured and/or input into or as part of the infrastructure to permit customization of the customer's “usual.” In the absence of a response from the customer, the default would be to give the customer the customer's “usual order.”

The present invention, in an alternative embodiment, provides for the customer programming the information that is associated with the customer's RFID tag. For example, the customer programs additional preferred choices for products and/or services from a business, secondary choices for products and/or services in the event that the preferred choice is not desired, and demographic information about the customer. The customer has the ability to determine the depth of the demographic information included and has the ability to opt out of including any demographic information at all. The demographic information is also used to help businesses determine what types of customers are frequenting their establishments as well as for collecting other pertinent business data. Other pertinent business data might be, for example, establishing correlations between customer traits and business sales or losses for a given period. This puts a statistical explanation behind a business trend—business intelligence. The ability to determine the depth of demographic information that is shared makes the customer less hesitant about the use of demographics as the customer does not have to worry that businesses are finding out too much information about the customer.

The presence of systematic, proactive security mechanisms throughout the infrastructure is an important element of the present invention. Without authentication or some other form of security, customers might not feel safe using the RFID system. Returning to FIG. 1, the authentication bit of the RFID card is checked (50), or in other words, the RFID data that identifies the customer will be read off of the card. If the authentication value is not positive (105), no authentication is needed, the customer is given the customer's order (110), and the transaction is executed (115). The transaction is then finished (120).

If authentication is required (55), the authentication is checked (60), and if validated (65), the customer is given the customer's order (110) and the transaction is executed (115). The transaction is then finished (120).

If the authentication is invalidated (66), then the number of occurrences of invalidation is checked (70), and if the number of occurrences of invalidation equals a certain number (75), then the RFID tag is disabled (80) and the transaction is aborted (90). The transaction is then finished (120).

In one embodiment of the present invention, the determination of whether authentication is required (55) would be customer defined in order to allow the customer to fine tune the level of security that the customer desires. The customer might want to require authentication for every fifth transaction, for every transaction over $20, or some other time period or amount desired by the customer for security purposes. In the preferred embodiment of the present invention, the present invention is programmed with the customer or business' choice how often and under which circumstances authentication is required (55). For example, in one embodiment of the present invention, the frequency that authentication is required (55) and purchase level that would trigger whether or not authentication is required (55) is tailored to the nature of the business or the transactions for which the RFID device is being used. High dollar transactions would most likely warrant increased levels of security, and thus, one or more high dollar transactions would often be instances in which authentication is required. to add a FIG. 3 if necessary to show that user communicates with merchant and merchant could operate locally.

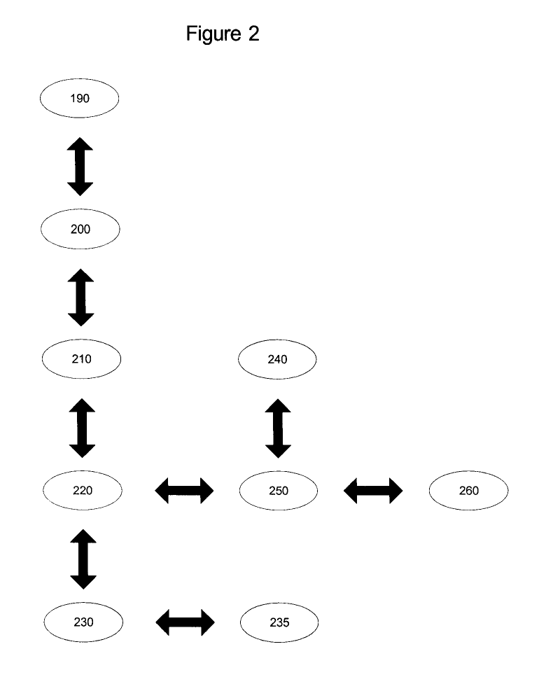

As shown in FIG. 2, in one embodiment of the design, the antenna (200) would receive the signal from the RFID customer tag (190), and the antenna (200) feeds the data to the RFID reader (210). The RFID reader (210) continuously scans its area for the presence of a RFID customer tag (190). Once the RFID reader (210) finds a RFID customer tag (190), it excites it to read its data. This is the first step in interpreting the data that is on the RFID tag (190). A forwarding device (220) (possibly a switch, or other device integrated into a router) will send information on the RFID tag (190) that has been sent to RFID reader (210) to a business interface (250) and also to a broadcasting device (230); the broadcasting device (230) capable of connecting to a network or the Internet.

This step is critical as the raw data is transmitted from the RFID tag (190) as aforementioned and shown in FIG. 2, so that the raw data from the RFID tag (190) eventually goes to the display screen (240) which displays and is interfaced with a conventional device that can queue any necessary data for the business process per the raw data from the RFID tag (190). For example, queuing would allow the merchant to process orders sequentially or shift orders depending upon the merchant's desires, much like the conventional order processing systems used in fast food restaurants today. Important is that the raw data from the RFID tag (190) is transmitted to the business interface (250) where the raw data might be preferably accessed from other franchises or businesses, or stored for later use. The raw data from the RFID tag (190) is handled by any devices in the business infrastructure. Essentially display screen (240), viewable by employees in a business such that a customer order could be filled or viewable by customers to confirm orders, allows communication with business interface (250). A conventional log file in business interface (250) can be employed to maintain a record of transactions. Also, the raw data from the RFID tag (190) can be sent to a recording device (260) such as a printer so that a receipt can be made of a transaction for a merchant or a customer.

In one embodiment of the design, the business interface (250) would be capable of completing behind the scenes processing. Such processing could include handling instructions from the merchant and communicating with remote devices such as a storage median, preferably a database. From the broadcasting device (230), a record that a particular transaction has occurred—along with particulars of the transaction such as RFID data, cost, and any other information related to the transaction—is relayed to a remote storage median (235), preferably a database, although technically remote storage median (235) could be onsite or even be a printed record. In the preferred embodiment of the present invention, the record that a particular transaction has occurred—along with particulars of the transaction such as RFID data, cost, and any other information related to the transaction—is relayed to remote storage median (235) that communicates the customer's desired order as well as keeps track of purchases or a variety of variables such as time of day, temperature, time of year. In one embodiment of the present invention, the remote storage median (235) would be able to store demographic information obtained by businesses about the customers or entered directly by the customer's over the Internet or some other network device. Customers would retain the right to opt out of this feature.

Different embodiments of the present invention account for mapping through the flowchart of the present invention with different user inputs. In various embodiments of the present invention, the following could occur: 1) “the usual”—completely automated; 2) without “the usual”—the system cancels out the regular transaction and orders something completely different (possibly from a list of other options that the user has programmed or that the business' server has recognized as frequent purchases of the customer); and 3) external factors (such as day of the week, temperature, time of day) a controlled “usual order” would occur based on the external factors.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention and the claims below.

Restated, the present invention is a purchasing device and process that is designed to make transactions faster and more efficient for both customers and businesses. The present invention allows the customer to transmit their “usual order” via a RFID tag that the customer might keep on their key chain, or elsewhere on their person, or in their vehicle. For example, the order, any customer specific information, or merely an identification number could be stored on the RFID tag. The signal from this RFID tag will be received and translated by an RFID reader (210) at the business. This would allow the customer to make a transaction sitting in their car at a drive-through or while inside the actual business, for example. In the preferred embodiment of the design, the RFID tag will contain information that will identify the customer to the business so that the customer's typical order will be known to the business without any verbal communication on the part of the customer. Businesses can access information regarding the customer's “usual order” by connecting to a remote storage median (235) that would contain this information or by reading the “usual order” right off of the RFID device. The business will then receive this information on a screen (240), printout (260), or possibly via some simulated voice recording and will be able to use the information to furnish the customer with the desired product without any actual verbal interaction with the customer. For example, a customer desiring to purchase a coffee at a drive-through window would simply have to pull up and have their RFID device scanned. The business would receive the information regarding the customer's usual order and prepare the order for the customer. The customer would receive their “usual order” and be charged electronically via a credit or debit card for their purchase, or through any payment account. The customer would simply need to pick up the customer's coffee and be on the customer's way. This would be the typical method of ordering.

In the preferred embodiment of the present invention, in deciding which product to furnish the consumer with, the present invention would even take into account user or business programmable inputs such as purchasing habits and other external factors such as preferred drinks on certain days, at certain times, or at certain temperatures. This would be able to replace the regular norm and become the norm when a particular condition is satisfied. For example, suppose the default is a regular coffee, but the customer has decided that whenever the temperature outside is greater then 70 degrees the customer wants an iced coffee. On days above 70 degrees, the present invention would automatically make it known that the customer wants an iced coffee. In one embodiment of the present invention, the RFID tag would is capable of supplying businesses with demographics on the customers who use the RFID tags. For example, businesses might be interested in seeing if a particular customer is always purchasing espressos, and the businesses might use this information to offer the customer a new type of espresso. Or, businesses could use the demographic information on the RFID tag in order to help them determine what type of clientele they have. Businesses could then tailor their advertising to this group of people. In the preferred version of the present invention, customers would be able to control just how much personal demographic and/or other information businesses are capable of viewing. For example, a customer might be willing to let a business view their age and sex, but not their home address and telephone number. In differing embodiments of the present invention, this information could be stored on the RFID tag itself, an internal business network, or even a remote storage median (235) which other businesses in the same industry could have access to. Additionally, user preferences could be associated with the RFID tag info so that abuse control exists with the data associated with the RFID tag. For example, if a user could modify the data associated with the RFID tag via any conventional means (Internet, for example) so that the user could choose to opt out of global or merchant specific mailings and other demographic/purchased derived marketing techniques, the user would feel more secure and business could save money.

The present invention, via the RFID tag, will also permit the consumer to pay electronically in multiple ways including, but not limited to, a debit account or charge account setup. Purchases and payments are made in a secure fashion. In the preferred embodiment of the present invention, the customer defines intervals between required verifications for purchases; that is, a dollar amount, above which verification is necessary, or some other method of requiring verification of the RFID tag. For example, the customer could specify that the customer wants to be required to sign for every third purchase or for every purchase over $20. The present invention would then automatically require a signature when those conditions are met. In addition, in the preferred embodiment of the present invention, the customer or the business would be able to determine the manner of verification. For example, verification could be performed by entering a PIN, providing a password, showing identification, signing a receipt, or any other method.

I claim:

1. A purchasing process for a customer and a business comprising:
identifying the customer's typical purchase as the customer nears the business; and
providing the customer with that which the customer desires by applying conditional logic to the customer's typical purchase.

2. The purchasing process of claim 1, wherein said communication identifying the customer's typical purchase is done via an electronic device.

3. (canceled)

4. The purchasing process of claim 1, further comprising the step of compiling data associated with the customer's purchase.

5. (canceled)

6. The purchasing process of claim 1, further comprising the step of processing payment.

7. The purchasing process of claim 1, further comprising permitting the customer to modify the customer's typical purchase with alternatives, for when the customer does not desire the customer's typical purchase.

8. The purchasing process of claim 1, further comprising utilizing an RFID to facilitate said identifying the customer's typical purchase as the customer nears the business.

9. (canceled)

10. (canceled)

11. (canceled)

12. A purchasing process for a customer and business comprising:
identifying the customer's typical purchase with electronic communication between the customer and the business;
providing a customer with that which the customer desires via an automated transaction by applying conditional logic to the customer's typical purchase before providing the customer with that which the customer desires; and processing payment electronically.

13. The purchasing process of claim 12, wherein said electronic communication is via wireless technology.

14. The purchasing process of claim 12, further comprising the step of electronically communicating the customer's preferred purchase.

15. The purchasing process of claim 12, further comprising the step of compiling customer data.

16. The purchasing process of claim 12, further comprising the step of processing payment via an RFID technology.

17. (canceled)

18. The purchasing process of claim 15, wherein the customer decides which data is compiled.

19. (canceled)

20. (canceled)

21. The purchasing process of claim 1, wherein said conditional logic is applied according to a value of a variable.

22. The purchasing process of claim 21, wherein said value is the time of day.

23. The purchasing process of claim 21, wherein said value determined when the customer nears the business.

24. The purchasing process of claim 21, wherein said variable is the day of the week.

25. The purchasing process of claim 21, wherein said variable is the outdoor temperature.

26. A purchasing process for a customer and a business comprising:
having the customer pre-select a desired purchase based upon at least one variable;
having the business determine that the customer is visiting the business;
having the business provide the customer's desired purchase after determining the value of said at least one variable.

27. The purchasing process of claim 26, wherein the business determines the value of said at least one variable when the customer is visiting the business; and wherein the customer does not provide the value of said at least one variable.
